(19) United States
(12) Patent Application Publication
(10) Pub. No.: US 2011/0119927 A1
(43) Pub. Date: May 26, 2011

(54) UTILITY KNIFE WITH FUNCTION HOOK CARABINEER

(76) Inventor: Kristopher Joseph Mueller, Asheville, NC (US)

(21) Appl. No.: 12/950,221

(22) Filed: Nov. 19, 2010

Related U.S. Application Data
(63) Continuation-in-part of application No. 12/713,942, filed on Feb. 26, 2010.
(60) Provisional application No. 61/216,503, filed on May 19, 2009.

(51) Int. Cl. B26B 1/08; B26D 3/08; B26B 1/10

(52) U.S. Cl. 30/162; 83/880

(57) ABSTRACT

The present invention generally relates to a knife with a hook portion. In one aspect, a utility knife is provided. The utility knife includes a handle having a first end with an opening and a second end with a hook portion. The utility knife further includes a blade and a blade holder disposed in the handle. The blade holder is configured to hold the blade, wherein the blade holder is movable relative to the handle between an extended position where a cutting edge of the blade extends through the opening of the handle and a retracted position where the cutting edge of the blade is disposed in the handle. In another aspect, a method of operating a utility knife is provided.

### CROSS-REFERENCE TO RELATED APPLICATIONS

This application is a continuation-in-part of U.S. patent application Ser. No. 12/713,942, filed Feb. 26, 2010, which claims benefit of U.S. provisional patent application Ser. No. 61/216,503, filed May 19, 2009. Each of the aforementioned related patent applications is herein incorporated by reference.

### BACKGROUND OF THE INVENTION

1. Field of the Invention

Embodiments of the present invention generally relate to a utility knife. More particularly, embodiments of the present invention relate to a utility knife having a hook portion.

2. Description of the Related Art

A conventional utility knife typically includes a handle and a blade. The blade in the conventional utility knife is movable relative to the handle between a retracted position and an extended position. In the retracted position, the blade is positioned within the handle, and in the extended position, a portion of the blade extends from the handle. The handle in the conventional utility knife may be made from a single piece or several pieces. Further, the body of the handle in the conventional utility knife is relatively straight. During a cutting operation, the user typically pushes on the knife or pulls on the knife in order to cut the material.

### SUMMARY OF THE INVENTION

The present invention generally relates to a knife with a hook portion. In one aspect, a utility knife is provided. The utility knife includes a handle having a first end with an opening and a second end with a hook portion. The utility knife further includes a blade and a blade holder disposed in the handle. The blade holder is configured to hold the blade, wherein the blade holder is movable relative to the handle between an extended position where a cutting edge of the blade extends through the opening of the handle and a retracted position where the cutting edge of the blade is disposed in the handle.

In another aspect, a method of operating a utility knife is provided. The method includes the step of providing the utility knife. The utility knife comprising a blade, a blade holder, a button, a handle having a first end with an opening and a second end with a hook portion. The method further includes the step of grasping the knife in a manner that utilizes the handle. The method also includes the step of manipulating the button on the knife to move the blade holder from a retracted position where a cutting edge of the blade is disposed in the handle to an extended position where the cutting edge of the blade extends through the opening of the handle. Additionally, the method includes the step of applying a force on the knife such that a portion of the force is applied to the hook portion of the handle.

In a further aspect, a utility knife is provided. The utility knife includes a handle having a hand grip positioned between a tail portion and a slip guard. The utility knife further includes a blade holder configured to hold a blade, wherein the blade holder is movable relative to the handle between an extended position where a cutting edge of the blade extends through an opening of the handle and a retracted position where the cutting edge of the blade is disposed in the handle. Additionally, the utility knife includes an arm member disposed proximate the tail portion. The arm member includes a first end attached to the handle at a pivot point.

In an additional aspect, a method of scoring a material is provided. The method includes the step of providing a utility knife comprising a blade, a blade holder, a button, and a handle having a first engagement portion and a second engagement portion. The method further includes the step of selecting a scoring depth and manipulating the button on the utility knife to move the blade holder to a position where a cutting edge of the blade extends through an opening of the handle. The method also includes the step of placing the utility knife on a surface of the material such the first and second engagement portions are in contact with the material. Additionally, the method includes the step of applying a force on the utility knife to score the material.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a view illustrating a knife with a blade in a retracted position.

FIG. 2 is a view illustrating the knife with the blade in an extended position.

FIG. 3 is a view illustrating a knife with a latch in a closed position.

FIG. 4 is a view illustrating the knife with the latch in an opened position.

FIG. 5 is a view illustrating a knife in an intermediate position.

FIG. 6 is a view illustrating the knife scoring an item.

### DETAILED DESCRIPTION

The present invention generally relates to a utility knife with a hook carabineer. To better understand the aspects of the present invention and the methods of use thereof, reference is hereafter made to the accompanying drawings.

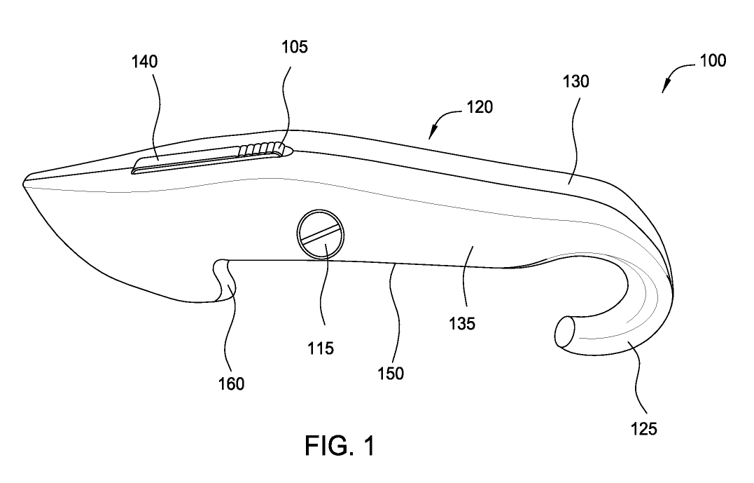

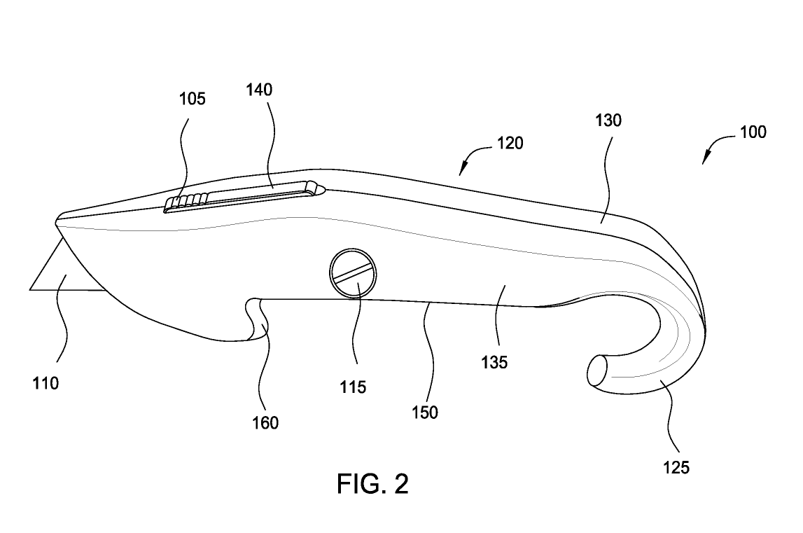

FIGS. 1 and 2 are views illustrating a knife 100 having a blade holder in a retracted position and an extended position. The blade holder is movable between the retracted and the extended position by manipulating a button 105 on an upper portion of the knife 100. In the extended position, the cutting edge of a blade 110 extends from an opening in a handle 120 of the knife 100. In the retracted position, the cutting edge of the blade 110 is disposed within the handle 120 of the knife 100. Further, the blade holder is movable to several intermediate positions between the retracted and the extended position by manipulating the button 105.

The handle 120 includes a first portion 130 and a second portion 135. The first portion 130 is attached to the second portion 135 by a connection member 115, such as a screw. The connection member 115 is configured to be removable to allow the first portion 130 to be removed from the second portion 135 in order to insert (or replace) the blade 110 in the blade holder. Each portion 130, 135 includes a cut out on an upper portion that forms a slot 140 when the portions 130, 135 are connected. The slot 140 is configured to allow the button 105 to slide as the button 105 moves the blade holder between the retracted position (FIG. 1) and the extended position (FIG. 2). The handle 120 includes a handgrip 150 disposed between a slip guard 160 and a hook portion 125 (e.g. a tail portion). The handgrip 150 is shaped such that the knife 100 will ergonomically fit in the hand of a user during a cutting operation. The handle 120 may be constructed from a metallic, a synthetic or a composite material.

The knife 100 may be used in a push-cutting operation in which the knife 100 is pushed in a direction away from the user to cut the material. In the push-cutting operation, the user grips the handgrip 150, and a front portion of the user's hand may engage the slip guard 160. As illustrated in FIGS. 1 and 2, the slip guard 160 extends below the handgrip 150. The slip guard 160 is configured to support (and protect) a front portion of the user's hand as the knife 100 is pushed in a direction away from the user in the push-cutting operation. In this manner, the slip guard 160 may be useful to prevent the user's hand from slipping off the front of the knife 100 during the push-cutting operation.

The knife 100 may be used in a pull-cutting operation in which the knife 100 is pulled in a direction toward the user to cut the material. In the pull-cutting operation, the user grips the handgrip 150, and a back portion of the user's hand may engage the hook portion 125 at an end of the knife 100. The hook portion 125 includes a tip that points in a direction toward the front of the knife 100 which holds the blade 110. As illustrated in FIGS. 1 and 2, the tip of the hook portion extends below the handgrip 150. The hook portion 125 is configured to support (and protect) the back portion of the user's hand as the knife 100 is pulled in a direction toward the user in the pull-cutting operation. In this manner, the hook portion 125 may be useful to prevent the user's hand from slipping off the back of the knife 100 during the pull-cutting operation. In one embodiment, the hook portion 125 is large enough to at least partially wrap around the hand of the user. Additionally, the hook portion 125 serves as a way to store the knife 100 in a belt loop, a wall hook tool, a pocket or a tool pouch. The hook portion 125 also allows the user to retrieve the knife 100 with one finger out of the pocket or the tool pouch.

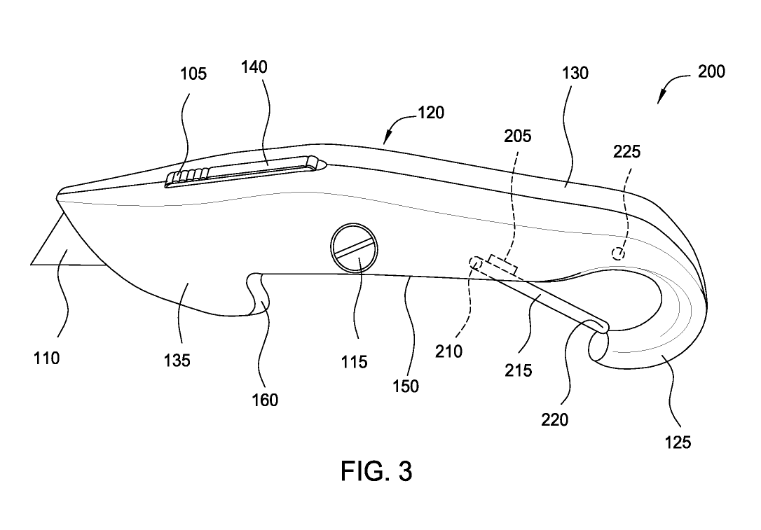

FIG. 3 is a view illustrating a knife 200 with the blade holder in an extended position. For convenience, the components on the knife 200 that are similar to the components on the knife 100 will be labeled with the same reference indicator. The knife 200 includes the blade holder that is movable between the retracted and the extended position by manipulating the button 105 on an upper portion of the knife 200. In the extended position, the cutting edge of the blade 110 extends from the handle 120 of the knife 200. In the retracted position (not shown), the cutting edge of the blade 110 is disposed within the handle 120 of the knife 200.

The knife 200 includes an arm member 215 (e.g., a carabineer arm) disposed near the hook portion 125. In one embodiment, the arm member 215 is a rod-shaped member or a flat plate member. The arm member 215 may be made from a metallic material or a composite material. The hook portion 125 and the arm member 215 allow the knife 200 to be attached and secured in any number of locations, such as a belt loop, a wall hook, a tool pouch, etc.

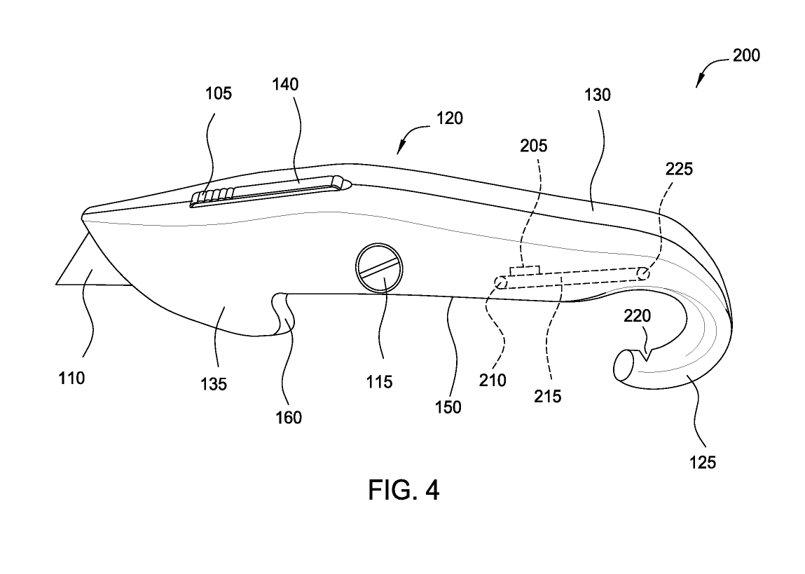

As shown in FIG. 3, one end of the arm member 215 is attached to the handle 125 at a hinge 210. The arm member 215 is configured to rotate around the hinge 210 between a closed position (FIG. 3) and an opened position (FIG. 4). A biasing member 205, such as a spring, is attached to the arm member 215 proximate the hinge 210. The biasing member 205 is configured to bias the arm member 215 in the closed position. Another end of the arm member 215 is configured to engage a notch 220 formed in the hook portion 125. The notch 220 holds the arm member 215 stationary when the arm member 215 is in the closed position.

FIG. 4 is a view illustrating the knife 200 with the arm member 215 in the opened position. To move the arm member 215 from the closed position to the opened position, a user applies a force to the arm member 215. When the force applied to the arm member 215 is greater than the force applied by the biasing member 205, the arm member 215 rotates around the hinge 210 toward the handle 210. A window (not shown) formed in the handle 120 is configured to receive the arm member 215 as the arm member 215 moves to the opened position. After the arm member 215 enters the window in the handle 120, an arm release member 225 disposed in the handle 120 engages a portion of the arm member 215 to hold the arm member 215 in the opened position (or storage position). In the opened position, the knife 200 may be used in a similar manner as set forth herein. To disengage the arm member 215 from the arm release member 225, the user may push on the arm member 215 or the user may push a button (not shown) attached to the arm release member 225. Once the arm member 215 is disengaged from the arm release member 225, the biasing member 205 urges the arm member 215 through the window in the handle 120 toward the closed position (FIG. 3). As set forth herein, in the closed position, the arm member 215 engages the notch 220 formed in the hook portion 125.

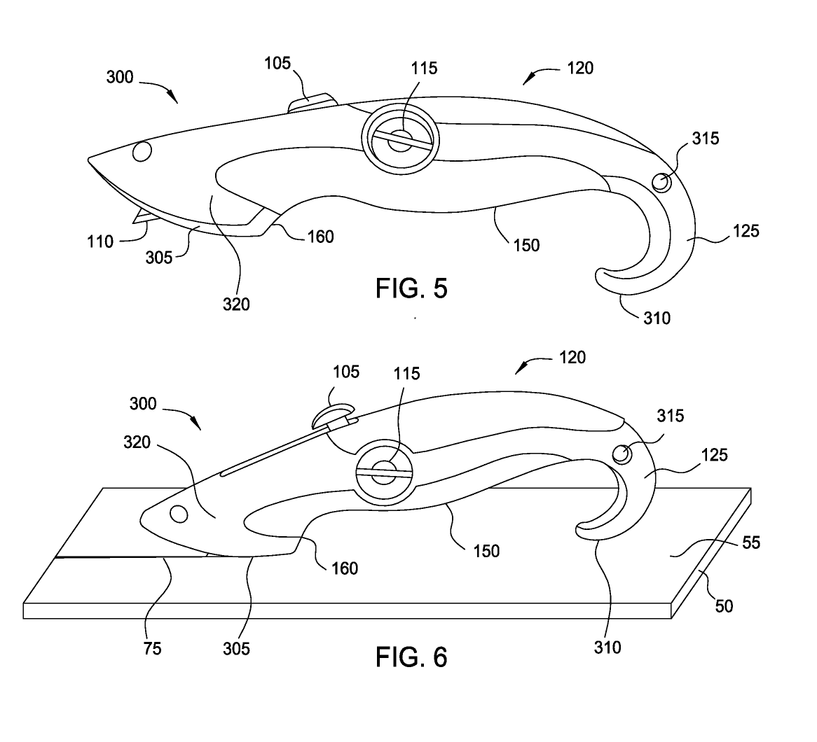

FIG. 5 is a view illustrating a knife 300 with the blade 110 in an intermediate position. For convenience, the components on the knife 300 that are similar to the components on the knife 100 will be labeled with the same reference indicator. The knife 300 includes a blade holder that is movable between a retracted position, several intermediate positions and an extended position by manipulating the button 105 on an upper portion of the knife 300. In the intermediate positions and the extended position, the cutting edge of the blade 110 extends from the handle 120 of the knife 300.

FIG. 6 is a view illustrating the knife 300 in a pull-scoring operation in which the knife 300 is pulled in a direction toward the user to score 75 a material 50. In the pull-scoring operation, the user grips the handgrip 150 between a first engagement portion (e.g. handgrip 150) and a second engagement portion (e.g. hook portion 125). Upon gripping the handgrip 150, a back portion of the user's hand may engage the hook portion 125 at a tail of the knife 300. The hook portion 125 is configured to support (and protect) the back portion of the user's hand as the knife 300 is pulled in the direction toward the user in the pull-scoring operation. In this manner, the hook portion 125 may be useful to prevent the user's hand from slipping off the back of the knife 300 during the pull-scoring operation.

Prior to the pull-scoring operation, the user selects the depth of the score (or cut) by manipulating the button 105 to move the blade holder to a position such that the blade 110 extends from the handle 120 an appropriate amount. Thereafter, the user positions the knife 300 on the material 50 to be scored by placing a bottom hook surface 310 of the hook portion 125 (first contact point) and a front bottom surface 305 of a front portion 320 (second contact point) into contact with an upper surface 55 of the material 50. The two contact points between the knife 300 and the upper surface 55 of the material 50 provide stability and control of the knife 300 during the pull-scoring operation. The two contact points also provide assistance in the positioning and guiding of the knife 300 on the material 50 in the pull-scoring operation. As shown in FIG. 6, the tip of the hook portion 125 extends below the handgrip 150 which allows the user's hand to be positioned away from the upper surface 55 of the material 50 to protect the user's hand during the pull-scoring operation. After the depth of the score has been set and the knife 300 is placed on the upper surface 55 of the material 50, the knife 300 is pulled in a direction toward the user to score 75 the material 50.

The knife 300 may be used in a push-scoring operation in which the knife 300 is used to score the material 50. In the push-scoring operation, the user selects the score (or cut) depth and manipulates the button 105 to move the blade holder to a position such that the blade 110 extends from the handle 120 an appropriate amount as set forth herein. Thereafter, the user places the knife 300 on the upper surface 55 of the material 50 at two contact points. The two contact points between the knife 300 and the material 50 provide assistance in the guiding (and positioning) of the knife 300 on the material 50 during the push-scoring operation. The two contact points also provide stability and control of the knife 300 as the knife is pushed in a direction away from the user to score 75 the material 50 during the push-scoring operation. As also shown in FIG. 6, the knife 300 includes a hole 315 formed in the hook portion 125. The hole 315 may be used to attach the knife 300 to a connection member for storage in any number of locations, such as a belt loop, a wall hook, a tool pouch, etc.

While the foregoing is directed to embodiments of the present invention, other and further embodiments of the invention may be devised without departing from the basic scope thereof, and the scope thereof is determined by the claims that follow.

1. A utility knife comprising:
a handle having a first end with an opening and a second end with a hook portion;
a blade;
a blade holder disposed in the handle, wherein the blade holder is configured to hold the blade, and wherein the blade holder is movable relative to the handle between an extended position where a cutting edge of the blade extends through the opening of the handle and a retracted position where the cutting edge of the blade is disposed in the handle.

2. The utility knife of claim 1, wherein the handle further includes a slip guard disposed between the first end and the second end of the handle.

3. The utility knife of claim 1, wherein the handle further includes a handgrip on a lower portion of the handle, the handgrip being disposed between the slip guard and the hook portion.

4. The utility knife of claim 3, wherein the slip guard extends to a point below the handgrip.

5. The utility knife of claim 1, further comprising an arm member having a first end attached to the handle by a hinge.

6. The utility knife of claim 5, wherein the arm member is rotatable around the hinge between a closed position and an opened position.

7. The utility knife of claim 6, wherein a second end of the arm member is configured to engage a notch in the hook portion when the arm member is in the closed position.

8. The utility knife of claim 6, wherein a second end of the arm member is configured to engage an arm release member disposed in the handle when the arm member is in the opened position.

9. The utility knife of claim 6, further comprising a biasing member disposed in the handle proximate the first end of the arm member.

10. The utility knife of claim 9, wherein the biasing member is configured to bias the arm member in the closed position.

11. A method of operating a utility knife, the method comprising:
providing the utility knife, the utility knife comprising a blade, a blade holder, a button, and a handle having a first end with an opening and a second end with a hook portion;
grasping the knife in a manner that utilizes the handle;
manipulating the button on the knife to move the blade holder from a retracted position where a cutting edge of the blade is disposed in the handle to an extended position where the cutting edge of the blade extends through the opening of the handle; and
applying a force on the knife such that a portion of the force is applied to the hook portion of the handle.

12. The method of claim 11, wherein the utility knife further includes an arm member having a first end attached to the handle at a pivot point.

13. The method of claim 12, further comprising rotating the arm member around the pivot point from a closed position to an opened position.

14. The method of claim 13, wherein a second end of the arm member is configured to engage a notch in the hook portion when the arm member is in the closed position.

15. The method of claim 13, wherein a second end of the arm member is configured to engage an arm release member disposed in the handle when the arm member is in the opened position.

16. A utility knife comprising:
a handle having a hand grip positioned between a tail portion and a slip guard;
a blade holder configured to hold a blade, wherein the blade holder is movable relative to the handle between an extended position where a cutting edge of the blade extends through an opening of the handle and a retracted position where the cutting edge of the blade is disposed in the handle; and
an arm member disposed proximate the tail portion, the arm member having a first end attached to the handle at a pivot point.

17. The utility knife of claim 16, wherein the arm member is rotatable around the pivot point between a closed position and an opened position.

18. The utility knife of claim 17, wherein a second end of the arm member is configured to engage a notch in the tail portion when the arm member is in the closed position.

19. The utility knife of claim 17, wherein a second end of the arm member is configured to engage an arm release member disposed in the handle when the arm member is in the opened position.

20. The utility knife of claim 17, wherein the handle comprises a window configured to receive the arm member when the arm member is in the closed position.

21. The utility knife of claim 17, wherein the tail portion comprises a hook.

22. A method of scoring a material, the method comprising:
providing a utility knife comprising a blade, a blade holder, a button, and a handle having a first engagement portion and a second engagement portion;
selecting a scoring depth and manipulating the button on the utility knife to move the blade holder to a position where a cutting edge of the blade extends through an opening of the handle;
placing the utility knife on a surface of the material such the first and second engagement portions are in contact with the material; and
applying a force on the utility knife to score the material.

23. The method of claim 22, wherein the second engagement portion comprises a hook portion.
